(19) United States
(12) Patent Application Publication
(10) Pub. No.: US 2023/0356212 A1
(43) Pub. Date: Nov. 9, 2023

(54) METHOD FOR DETERMINING DIETARY FIBER AND A SAMPLE CONTAINER

(71) Applicant: FOSS Analytical A/S, Hilleroed (DK)

(72) Inventor: Rasmus VISTISEN, Hilleroed (DK)

(73) Assignee: FOSS Analytical A/S, Hilleroed (DK)

(21) Appl. No.: 18/245,440

(22) PCT Filed: Aug. 11, 2021
(86) PCT No.: PCT/IB2021/057392

§ 371 Date: Mar. 15, 2023

(30) Foreign Application Priority Data
Oct. 6, 2020 (DK) PA202001149

(51) Int. Cl. B01L 3/00; B01F 27/072; B01F 27/192

(52) U.S. Cl. CPC B01L 3/502; B01F 27/0721; B01F 27/192; B01F 27/0724; B01L 2300/0681; B01L 2300/042

(57) ABSTRACT

A sample container for use in determining a dietary fiber content of a food sample may include a chamber having a first end, an opposing second end, and a side-wall connecting the first end to the second end. The side-wall may include a rigid, non-porous material. The sample container may include a porous filter located at the second end of the chamber. The sample container may include an integral stirrer located within the chamber.

### CROSS-REFERENCE TO RELATED APPLICATIONS

This application is a National Stage of PCT/IB2021/057392, filed on Aug. 11, 2021, which claims priority to Danish Patent Application PA202001149, filed on Oct. 6, 2020 in the Danish Patent and Trademark Office, the entire contents of each of which are incorporated herein in their entirety.

### BACKGROUND

The present invention relates to a method for determining dietary fiber and to a sample container for use in the same. In particular the invention relates to the determination of total dietary fiber.

The determination of the dietary fiber content of food for animal consumption (commonly referred to as ‘crude fiber’ content) is a valuable aid in the prediction of its nutritional value to the animals. The level of dietary fiber provided by food for human consumption is also important to determine as dietary fiber is known to benefit human health by aiding digestion and helping to prevent heart disease. For these reasons at least, food manufacturers invest research and resources into means of optimising the dietary fiber content of their products and it is therefore important for the industry to have reliable and accurate means of measuring this dietary fiber.

Many methods exist for the determination of dietary fiber in both human and animal food such as, for example methods approved by the Association of Official Analytical Chemists (AOAC) like, “Total, Soluble, and Insoluble Dietary Fiber in Foods” (AOAC Method 991.43) and “Analysis of Crude Fiber in Feed” (AOAC 978.10). Generally such methods are enzymatic/gravitation methods and involve the steps of dissolving non-fiber components in a neutral or acid detergent solution or an acid solution followed by alkaline solution, typically whilst undergoing heating and stirring; recovering the residual insoluble dietary fiber fraction by filtration and washing; and determining the weight of the recovered dietary fiber after drying. The determination of total dietary fiber involves an additional step of precipitating the soluble fiber fraction using alcohol and recovering this precipitate by filtration and weighing. Additionally, according to the known methods for dietary fiber determination, the so determined weight(s) needs to be corrected for protein and ash content of the sample which is also present in the solids that are isolated from the solution(s) after the dissolving and optional precipitation steps.

Such methods typically require weights to be determined with an accuracy of ±0.005 g. It is therefore important that essentially all of the dietary fiber obtained from the dissolving and the optional precipitation steps described above is made available for weighing.

To this end, it is known from, for example U.S. Pat. No. 9,182,382, to provide a sample container for use in the determination of dietary fiber consisting of a flexible reaction/filter chamber made of a combination of porous and non-porous materials and divisible into separate compartments by means of a releasable seal. The chamber is configured with an open first end; an opposing second end which is formed of a porous material; and a flexible side-wall of non-porous material connecting the two ends. By this container the problematic transfer of mixtures between beakers and filters is eliminated and thus the problem of loss of recovered fiber between such transfers is mitigated. However, transfer of sample mixture from one compartment to another is still required which may lead to some material remaining in the first compartment and thus lost to any further processing in the second and subsequent compartments.

A method of analysing a sample to determine a dietary fiber content is also disclosed in U.S. Pat. No. 9,182,382 and utilizes the sample container disclosed in that document. The method comprises placing the sample into a chamber of the disclosed container; weighing the combined sample and container to obtain a first weight; reacting the sample in the chamber with one or more enzymes in solution whilst heating and stirring to obtain an insoluble dietary fiber fraction; allowing the solution to pass through the filter and into a second container similar to the first and precipitating out a soluble dietary fiber fraction by adding an alcohol solution to the solution in the second container; filtering the precipitation solution through the filter of the second container; and drying and weighing both the insoluble and the soluble dietary fiber fractions in the two containers.

### SUMMARY

It is an aim of the present invention to further mitigate loss of recovered dietary fiber when determining dietary fiber content of samples.

According to a first aspect of the present invention there is provided a sample container comprising a chamber having a first end; an opposing second end; a side-wall connecting the first end to the second end and formed of a rigid, non-porous material; and a porous filter located at the second end through which liquid from the chamber may be passed; wherein the sample container further comprises an integral stirrer located within the chamber.

In some embodiments the stirrer comprises a shaft extending a distance into the container along an axis which is generally parallel to the rigid side-wall; and a number of blades mounted on the shaft for rotation about the axis.

In some embodiments a first end of the shaft is located in the chamber and is, towards a second end of the shaft which is opposite the first end of the shaft, fixedly located at the second end of the chamber; and the number of blades is mounted for rotation about the shaft. The shaft may be a tube having a lumen which extends from the second end of the shaft and towards the first end of the shaft, the lumen being in operable connection to the number of blades towards the first end of the shaft and made accessible to external of the chamber via the second end of the shaft. The lumen may be made co-extensive with the shaft; and the number of blades is configured to sealingly engage with the open first end of the shaft to prevent ingress of material from the chamber into the lumen.

In some embodiments the shaft extends into the chamber a distance selected so that, in use, the first end of the shaft is located above material in the chamber. This also helps prevent ingress of material from the chamber into the lumen.

In some embodiments the shaft, towards its second end, may be rotatably located at the second end of the chamber, such as in a bearing provided at this second end, and the one or more blades may be fixed to the shaft for rotation therewith. This permits the shaft to rotated directly from external of the chamber and facilitates the manufacture of the sample container since the shaft need no longer be hollow and since the number of blades may be fixedly secured directly to the shaft.

In some embodiments the sample container further comprises a deflection surface, which may be formed as a part of the stirrer, collocated with the first end of the shaft and configured to deflect material that is incident on it from outside of the container into the chamber in a direction towards the side-wall and away from the shaft. This has an advantage that sample can be better stirred by the stirrer as it is located away from the centre of the container and the axis about which the stirrer is configured for rotation.

In some embodiments the sample container also comprises a lid which engages with an outer periphery of the side-wall at the first end of the chamber and is adapted for rotation in a plane parallel to the first end, the number of blades being mechanically connected to the lid for rotation therewith. In some embodiments the lid may be provided with cog teeth about an external periphery which, in use, can engage a rotatable cog wheel of an external actuator to rotate in unison therewith. In this manner rotation of the blades may be effected without external access to inside of the chamber.

In some embodiments the stirrer comprises a number of magnetic stir-bars (so-called ‘fleas’) located within the chamber. Thus no physical connection between internal and external of the chamber is necessary in order to actuate the stirrer.

According to a second aspect of the present invention there is provided a method for determining a dietary fiber content of a sample, the method comprising: providing a sample container; placing a food sample into the sample container and obtaining a first weight; performing an enzymatic digestion of the food sample in the sample container; separating a solid residue from liquid in the sample container by filtration through the filter of the sample container; drying the sample container and solid residue; obtaining a second weight; calculating a difference between the first and the second weights; and determining the dietary fiber content of the food sample dependent on the calculated difference; wherein the sample container is a sample container according to the first aspect of the present invention and wherein the first and the second weights consist of the combined weights of the sample container and its contents. Thus, a single container is employed so that problems associated with loss of material during transfer between containers is removed. Moreover, the use of an integral stirrer further mitigates loss of any recovered fiber since the stirrer remains within the sample container and any fiber deposited on to the stirrer remains to be weighed.

In some embodiments the step of reacting the sample in the sample chamber comprises adding an alcohol solution to the enzymatic solution, preferably while stirring, to precipitate out a soluble dietary fraction from the enzymatic solution in the sample chamber.

In some embodiments the step of passing the liquid in the container through the filter comprises a step of generating a first pressure gradient across the filter in a direction to create a lower pressure outside the chamber than inside the chamber. This helps speed up filtration.

In some embodiments the step of reacting the sample in the chamber with at least an enzymatic solution comprises a step of generating a second pressure gradient across the filter in a direction to create a higher pressure outside the chamber than inside the chamber during the step of reacting the sample in the chamber. This helps prevent egress of liquid through the filter.

Most usefully, the method also comprises a step of determining a weight of protein and a weight of ash in the solid residue in the sample container and the step of determining a dietary fiber content comprises correcting the second weight for the weights of protein and of ash.

According to a third aspect of the present invention there is provided a system for determining a dietary fiber content of a food sample, the system comprises a number of sample containers; a plurality of liquid reservoirs selectively fluidly connectable with the number of sample containers to deliver liquid thereto; and a controller operably connected to at least the plurality of liquid reservoirs and adapted to control the operation of the system to perform the method according to the second aspect of the present invention wherein each of the number of sample containers consists of a sample container according the first aspect of the present invention.

### BRIEF DESCRIPTION OF THE DRAWINGS

These and further advantages, modifications and embodiments of the present invention will now be further described with reference to the accompanying figures, of which:

FIG. 1 Shows a schematic representation of a first embodiment of a sample container according to the first aspect of the present invention;

FIG. 2 Shows a schematic representation of a second embodiment of a sample container according to the first aspect of the present invention;

FIG. 3 Shows a schematic representation of a third embodiment of a sample container according to the first aspect of the present invention;

FIG. 4 Shows a flow-chart representation of an embodiment of the method according to the second aspect of the present invention; and

FIG. 5 Shows a schematic representation of a system according to the present invention.

### DETAILED DESCRIPTION

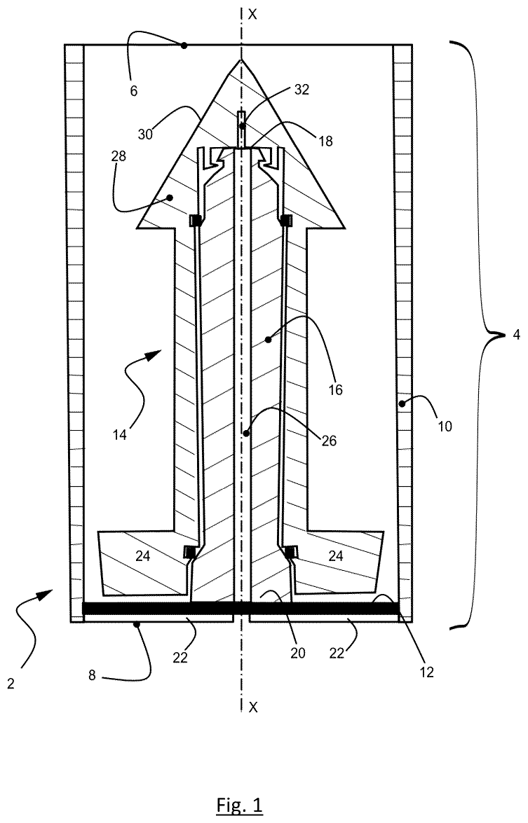

A first embodiment of a sample container 2 according to the present invention is illustrated in FIG. 1. The sample container 2 comprises an elongate cylindrical chamber 4 having an open first end 6; a second end 8 opposing the first end 6 and a long side-wall 10 which connects the first end 6 to the second end 8. The long side-wall 10 is formed of a rigid, non-porous material, such as polypropylene or polyester. A filter 12 is provided at, and in some embodiments may be formed integral with, the second end 8 which is otherwise sealed against egress of liquids from the chamber 4. The filter 12 is porous and is, in the present embodiment, also hydrophobic in nature. The filter 12 being hydrophobic helps control the retention of liquid within chamber 4 for a time necessary to allow digestion and precipitation to occur, as described below. The sample container 2 further comprises a stirrer 14 which is located within the chamber 4.

In the present embodiment the stirrer 14 comprises a shaft 16 which extends along an axis X that is generally parallel to the rigid side-wall 10 and is preferably located centrally of the chamber 4. The shaft 16 has a first end 18 within the chamber 4 and a second end 20 which located at the second end 8 of the chamber 4, here by means of supports 22 which extend radially from the side-wall 10 and are attached to the shaft 16 in order to fixedly locate it centrally at the second end 8 of the chamber 4. The present stirrer 14 also comprises a number of blades 24 (here for example two generally ‘L’ shaped blades are illustrated) that are mounted on the shaft 16 for rotation about the axis X.

By way of example, the shaft 16 may comprise an open-ended hollow tube, the lumen 26 of which passes the entire length of the shaft 16 from the first end 18 to the second end 20 and provides a passageway for a drive shaft (not shown) which couples an actuator (not shown) located external of the sample container 2 to the number of blades 24. In the present embodiment the blades 24 connect at one end to form a cap 28 which is engagement with the first end 18 of the shaft 16 and helps cover the first end 18 of the shaft 16 to prevent ingress of sample and solutions into the open lumen 26. The cap 28 may usefully be formed with a deflection surface 30 which acts to deflect incident material from outside of the chamber 4 in a direction towards the side-wall 10 and away from the shaft 16. The cap 28, in some embodiments and as illustrated, may be conoidal, tapering towards the open first end 6 of the chamber 4. The cap 28 of the present embodiment is also provided with a connector 32, here in the form of a narrower lumen coaxially located with and displaced along the axis X from, the open lumen 26 of the shaft 16, which connector 32, in use, engages, such as by a push-fit engagement, with the drive shaft to operably couple the number of blades 24 to the external actuator.

In other embodiments the drive shaft may be a component of the sample container 2 and be fixedly attached to the number of blades 24. For example, the drive shaft may be attached to the cap 28 and extend along the open lumen 26 to terminate proximal the second end 8 of the chamber 4.

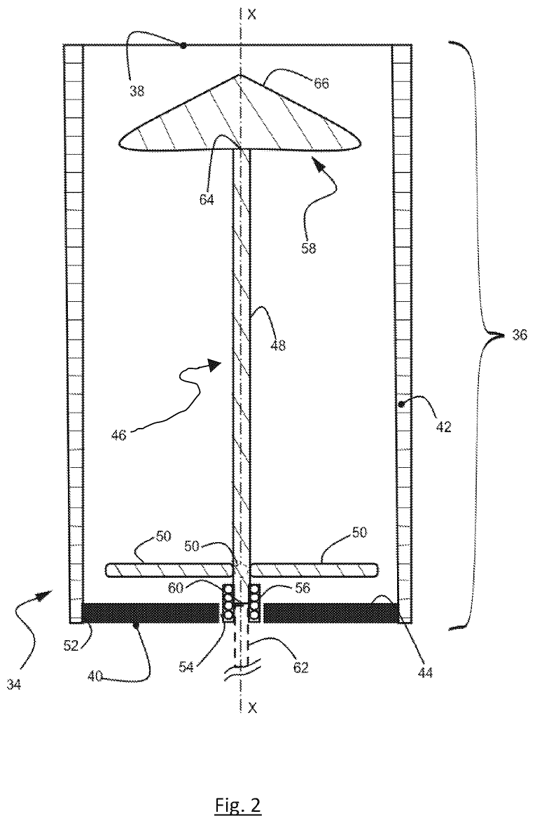

A second embodiment of a sample container 34 according to the present invention is illustrated in FIG. 2. The sample container 34 is generally constructed in the same manner as the sample container 2 of the first embodiment in that it comprises an elongate cylindrical chamber 36 having an open first end 38; a second end 40 opposing the first end 6 and a long side-wall 42 which connects the first end 38 to the second end 40. The long side-wall 42 is formed of a rigid, non-porous material. The second end 40 is formed from by a porous, hydrophobic filter 44. The sample container 34 further comprises a stirrer 46 which is located within the chamber 36 and comprises a shaft 48 which extends along an axis X that is generally parallel to the rigid side-wall 42 and is preferably located centrally of the chamber 36; and a number of blades 50.

In the present embodiment the filter 44 forms the second end 40 of the container and is bonded about its periphery 52 to the rigid non-porous side-wall 42. A through hole 54 is provided in the filter 44 and is positioned to lie along the axis X. A rotatable bearing 56 is sealed in the through hole 54 and the shaft 48 has a first end 58 which terminates within the chamber 36 and an opposing second end 60 which is mounted in the bearing 56 for rotation therewith.

Usefully the shaft 48 may be a solid shaft to which the number of blades 50 are fixed. This facilitates construction of the stirrer 46 which may be formed as a single unit, for example using common injection moulding techniques or by an additive manufacturing process (‘3-D printing’). In some embodiments the first end 58 of the shaft 48 may be terminated with a flat face 64. In other embodiments, as is illustrated in FIG. 2, the first end 58 of the shaft 48 may be formed with a deflection surface 66 facing the open first end 38 of the chamber 36.

The rotatable bearing 56 is couplable to an external actuator, for example by means of a drive shaft 62 (broken line construction in FIG. 2) that establishes a mechanical connection between the actuator and the bearing 56 to rotate the bearing 56 as the actuator operates to rotate the drive shaft 62. In some embodiments, and as illustrated in FIG. 2, the drive shaft 62 is configured for a reversible push-fit engagement with the bearing 56 and does not form a component of the sample container 34 according to the present invention.

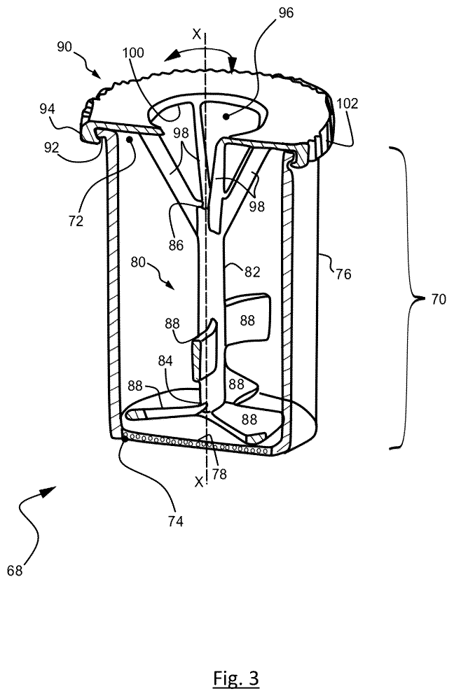

A third embodiment of a sample container 68 according to the present invention is illustrated in FIG. 3. The sample container 68 comprises an elongate cylindrical chamber 70 having an open first end 72; a second end 74 opposing the first end 72; a long side-wall 76 of a rigid non-porous material which connects the first end 72 to the second end 74; and a filter 78 which closes the second end 74 of the chamber 70 which filter 78, in some embodiments, is formed of a hydrophobic material. The sample container 68 further comprises a stirrer 80 which is located within the chamber 70.

The stirrer 80 comprises a shaft 82 which extends along an axis X that is generally parallel to the rigid long side-wall 76 centrally of the chamber 70, the shaft 82 having a first end 84 located towards the second end 74 of the chamber 70 and a second end 86 located towards the open first end 72 of the chamber 70; and a number of blades 88 mounted on the shaft 82.

The sample container 68 also comprises a lid 90 which overlays the open first end 72 of the chamber 70 for rotation about an outer periphery, here a lip 92, of the open first end 72 in a plane parallel to the open first end 72. The lid 90 is, in the present embodiment, provided with a lug portion 94 which engages, such as by known ‘snap-fit’ engagement, the lip 92 to inhibit separation of cap lid and chamber 70. A through-hole 96 is provided in the lid 90 which allows material, such as liquids and sample material (if not loaded into the chamber 70 before the lid 90 is placed over the open first end 72), to be placed in the chamber 70 during use. Supports 98 extend from an underside 100 of the lid 90 into the chamber 70 and connect to the shaft 82, here towards its second end 86, to locate it along the central axis X. Cog teeth 102 are provided about the outer periphery of the lid 90 which, in use, engage with cog teeth of a cog wheel of an external actuator (not shown). The external actuator is configured to operate to rotate the cog wheel which in turn will rotate the lid 90 and cause rotation of the stirrer 80 about the axis X and thereby agitation of the contents of the chamber 70.

In some embodiments the shaft and blade type stirrer described above may be replaced with other known stirring devices, such as magnetic stir-bars, which comprise moveable physical elements for stirring the contents of the chamber and which are provided as a component of the sample container.

For purposes of illustration only, an exemplary embodiment of the method according to the present invention will now be described in relation to the method for determining the total, soluble and insoluble dietary fiber in foods according to the AOAC 991.43 method (the contents of which are contained herein by reference). This requires that duplicate samples of dried foods, fat-extracted if containing >10% fat, undergo sequential enzymatic digestion by heat stable α-amylase, protease, and amyloglycosidase to remove starch and protein. For total dietary fiber (TDF), enzyme digestate is treated with alcohol to precipitate soluble dietary fiber (SDF) before filtering and TDF residue is washed with alcohol and acetone, dried, and weighed. For insoluble and soluble dietary fiber (IDF and SDF), enzyme digestate is filtered, and residue (IDF) is washed with warm water, dried and weighed. For SDF, combined filtrate and washes are precipitated with alcohol, filtered, dried, and weighed. TDF, IDF, and SDF residue values are corrected for protein and ash.

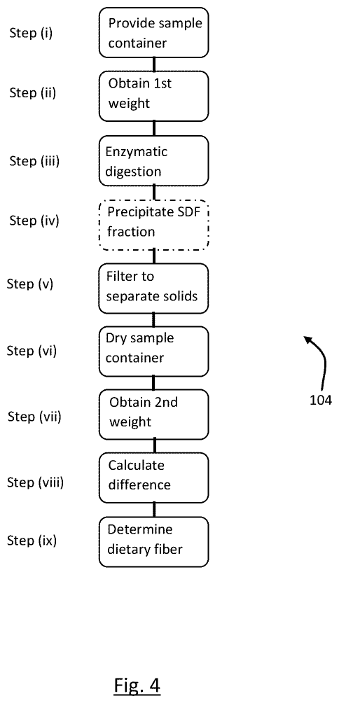

With reference to FIG. 4, a method 104 for determining dietary fiber content of a food sample comprises: providing a sample container 2;34;68 according to the first aspect of the present invention, Step (i); placing the food sample into the chamber 4;36;70 of the sample container 2;34;68 and obtaining a first combined weight of food sample and sample container 2;34;68, Step (ii); performing enzyme digestion for a time sufficient to establish a liquid digestate and a solid residue by adding enzymes in solution to the chamber 4;36;70 containing the food sample and stirring using the integral stirrer 14;46;80 (typically heating also), Step (iii); optionally precipitating an SDF fraction from the enzyme digestate in the chamber 4;36;70 of the sample container 2;34;68, Step (iv); separating the solid residue and the SDF fraction in the chamber 4;36;70 from liquids in the chamber by filtration through the filter 12;44;78 at the second end 8;40;74 of the chamber 4;36;70, Step (v); drying the sample container 2;34;68, Step (vi); obtaining a second combined weight of solids and sample container 2;34;68 (including the integral stirrer 14;46;80), Step (vii); calculating a difference between the first combined weight and the second combined weight, Step (viii); and determining the dietary fiber content in dependence on the calculated difference, Step (ix).

In some embodiments filtration at Step (v) may be enhanced by establishing a pressure gradient across the filter 12,44,78 in a direction to enhance transportation of liquid from inside the chamber 4;36;70 to outside the sample container 2;34;68.

In some embodiments the Step (viii) of calculating the difference between the first combined weight and the second combined weight comprises determining protein and ash content of the sample and correcting the second combined weight for the determined protein and ash content.

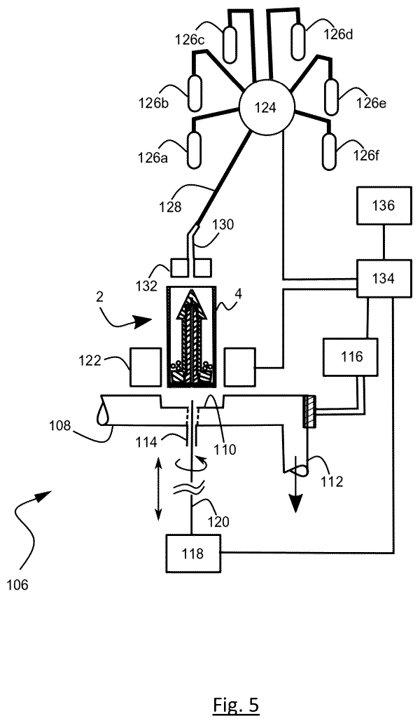

An embodiment of a system 106 according to the third aspect of the present invention is illustrated in FIG. 5 for the automated application of the method according to the second aspect of the present invention which was described above. The system 106 comprises a number (here one) of sample containers according to the present invention. For ease of description reference will be made in this embodiment, by way of example only, to the sample container 2 which is illustrated in FIG. 1 and described above. A fluid manifold 108 of the system 106 is configured with a number (here one) of lower interfaces 110 which receives and releasably retains a corresponding sample container 2 and establishes a fluid tight connection between the second end 8 of the chamber 4 and internal of the fluid manifold 108. The fluid manifold 108 has an outlet 112 to waste and a passageway 114 connected with each interface 110. In some embodiments each interface 110 may include a valving system which is operable to control the flow of liquids out of the second end 8 of the interfaced chamber 4 and into the fluid manifold 108. The system 106 of the present embodiment additionally comprises an optional pump 116 connected to the fluid manifold 108 and which is operable to at least generate less than ambient pressure (under-pressure) in the fluid manifold 108 to aid in filtration as described below. In some embodiments the pump 116 is operable to also generate above ambient pressure (over-pressure) in the fluid manifold 108 to help retain material in the chamber 4 for a sufficient time to permit digestion and/or precipitation. An actuator 118 is provided which is operable to rotate a spindle 120 which passes through the passageway 114, the open lumen 26 and connects to the connector 32 of the stirrer 14 when a sample container 2 is retained by the associated lower interface 110. A temperature regulator 122 of known construction, which in some embodiments may comprise a heater unit and in other embodiments may comprise a heater/cooler unit, is operable to regulate the temperature, for example to heat, the number of sample containers 2. A multi-way valve 124 is configured to selectively couple of a one of a plurality of liquid reservoirs (here six illustrated) 126a-126f with a conduit 128 that connects with an inlet 130 of an upper interface 132 of a number of upper interfaces (here one illustrated). For example, water 126a, ethanol 126b, acetone 126c, sodium hydroxide 126d, hydrochloric acid 126e and enzyme solution(s) 126f may be contained in an own one of the plurality of reservoirs 126a-126f. Each of the number of upper interfaces 132 is configured to direct transfer of liquid through the first end 6 of a corresponding sample container 2 into the chamber 4 and in some embodiments forms a fluid tight connection therewith. A controller 134 is provided to control the operation of the system 106 to automatically perform a determination of dietary fiber content of a food sample, for example according to the AOAC 991.43 method.

In use, an operator inserts a pre-weighed sample container 2 containing a food sample, typically 1 g±0.005 g, into the associated lower interface 110 and manually connects the associated upper interface 132 to the open first end 6 of the chamber 4. In some embodiments connection with one or both of the lower interface 110 and the upper interface 132 may be done automatically using mechanical elements known in the art. In some embodiments the operator may be prompted to enter the weight of the pre-weighed sample container and food sample into the system 106 via a user interface (not shown) of an associated data processor 136 as a first combined weight. In other embodiments the sample container 2 may include a machine readable label on which this weight is previously stored. The label is of a known type and may be a bar code or radio frequency identity (RFID) chip which will be automatically read by the system 106 using a corresponding reader (not shown) of known type and the previously stored weight provided to the data processor 136.

Once the desired number (here one illustrated) of sample containers 2 are inserted into the system 106 the user may initiate the automatic fiber content determination for example by pressing “Start” on the user interface. On initiation the controller 134 of the present embodiment operates to control the multi-way valve 124 to transfer liquid from selected reservoirs 126a-126f as appropriate during the determination; the temperature regulator in order to establish and maintain a predetermined temperature in the chamber 4 of the sample container 2; the actuator 118 to rotate the blades 24 and stir the contents of the chamber 4; the pump 116 to optionally create an over-pressure in the fluid manifold 108 which, via the lower interface 110, generates a pressure gradient across the filter of the second end 8 of the chamber 4 in a direction to inhibit the flow of liquids from the chamber 4; the pump 116 to generate an under-pressure in the fluid manifold to enhance the flow of liquids from the chamber 4. In some embodiments the controller 134 is configured to also control the components of the system 106 to effect flushing of the chamber 4 after precipitation or enzymatic digestion, depending on whether TDF or insoluble dietary fiber (IDF) fractions are to be determined for the food sample.

In some embodiments, the controller 134 is further configured to control the components of the system 106 to rinse the contents of the sample container(s) 2 with acetone from one of the reservoirs 126c and to activate the temperature regulator 122 to dry the residue within the chamber 4. The sample container(s) 2 may then be removed from the system 106 and weighed on a weighing device to obtain a second combined weight which is the weight of solid residue in the chamber 4 and the sample container 2, including the stirrer 14 and which is provided to the data processor 136, for example as user input via a user interface or transmitted to the data processor 136 as digital information generated by the weighing device. In other embodiments a weighing device may be included as a component of the system 106 and the second combined weight may then be obtained within the system 106. Duplicate samples are used to determine in a known manner the protein and ash content of the food sample and provided to the data processor 136. The second combined weight is corrected for ash and protein content in the data processor 136. The weight of dietary fiber in the food sample is then calculated in the data processor 136 dependent on a difference between the first combined weight and the so corrected second combined weight.

It will be understood by those skilled in the art that the foregoing contains description of exemplary embodiments only of the present invention and that various changes in detail may be made, elements omitted and combinations of various elements of these embodiments may be done without departing from the invention as defined by the appended claims.

1. A sample container for use in determining a dietary fiber content of a food sample, the sample container comprising:
a chamber having a first end, an opposing second end, and a side-wall connecting the first end to the opposing second end, the side-wall including a rigid, non-porous material;
a porous filter at the opposing second end of the chamber; and
an integral stirrer within the chamber.

2. The sample container according to claim 1, wherein the integral stirrer comprises a plurality of blades configured to rotate around an axis that is parallel to the side-wall, the axis passing centrally through the first end and the opposing second end.

3. The sample container according to claim 2, wherein the integral stirrer comprises
a rotatable shaft extending within the chamber in a direction between the first end and the opposing second end, whereas the plurality of blades are mechanically connected to the rotatable shaft, wherein one end of the rotatable shaft is exposed to an exterior of the chamber.

4. The sample container according to claim 3, wherein the integral stirrer comprises
a deflection surface at an end of the rotatable shaft that is closer to the first end of the chamber than to the opposing second end of the chamber, the deflection surface configured to deflect incident material that is received into the chamber from the exterior of the chamber in a direction towards the side-wall of the chamber.

5. The sample container according to claim 2, further comprising:
a lid, the lid configured to engage an outer periphery of the side-wall at the first end of the chamber, the lid configured to rotate in relation to the chamber and in a plane parallel to the first end, wherein the plurality of blades are mechanically connected to the lid, such that the plurality of blades are configured to rotate around the axis based on rotation of the lid in relation to the chamber.

6. The sample container according to claim 5, wherein the lid includes cog teeth extending around an outer periphery of the lid.

7. A method for determining a dietary fiber content of a food sample, the method comprising:
providing the sample container of claim 1;
placing the food sample into the sample container and determining a first combined weight of the sample container and at least the food sample that is within the sample container;
performing an enzymatic digestion of the food sample in the sample container to establish a liquid digestate and a solid residue within the sample container subsequently to determining the first combined weight;
separating the solid residue from liquid in the sample container based on filtration through a filter of the sample container such that the solid residue remains within the sample container;
drying the sample container and the solid residue while the solid residue remains within the sample container;
determining a second combined weight of the sample container and at least the solid residue while the solid residue remains within the sample container;
calculating a difference between the first combined weight and the second combined weight; and
determining the dietary fiber content of the food sample based on the calculated difference.

8. The method according to claim 7, further comprising:
precipitating out a soluble dietary fiber fraction from the liquid in the sample container subsequently to performing the enzymatic digestion and prior to performing the separating of the solid residue from the liquid in the sample container.

9. The method according to claim 7, wherein the calculating the difference includes
determining a weight of protein and a weight of ash in the solid residue in the sample container,
correcting the second combined weight for the weight of protein and the weight of ash to determine a corrected second combined weight, and
determining a difference between the first combined weight and the corrected second combined weight.

10. A system for determining a dietary fiber content of a food sample, the system comprising:
a plurality of sample containers, each sample container of the plurality of sample containers including
a chamber having a first end, an opposing second end, and a side-wall connecting the first end to the opposing second end, the side-wall including a rigid, non-porous material,
a porous filter at the opposing second end of the chamber, and
an integral stirrer within the chamber;
a plurality of liquid reservoirs configured to be selectively fluidly connectable with the plurality of sample containers to deliver liquid thereto; and
a controller operably connected to at least the plurality of liquid reservoirs, the controller configured to control the system to perform the method according to claim 7.
